(19) United States
(12) Patent Application Publication
(10) Pub. No.: US 2024/0256935 A1
(43) Pub. Date: Aug. 1, 2024

(54) Multi-Qubit Entangling Measurements in Linear Optics

(71) Applicant: ORCA Computing Limited, London (GB)

(72) Inventors: Alex NEVILLE, London (GB); Brendan PANKOVICH, Toronto (CA)

(21) Appl. No.: 18/332,652

(22) Filed: Jun. 9, 2023

(30) Foreign Application Priority Data
Jan. 25, 2023 (GB) 2301051.5

(51) Int. Cl. G06N 10/40

(52) U.S. Cl. CPC G06N 10/40

(57) ABSTRACT

An apparatus includes an optical circuit with an interferometer and a detector arrangement. The interferometer is arranged to receive, as 2N input optical modes, N dual-rail encoded photonic qubits, each photonic qubit encoded as probability amplitudes corresponding to the photon occupation of two orthogonal optical modes, where N>2. The interferometer is arranged to interfere the N dual-rail encoded photonic qubits such that (i) a beamsplitter interaction is performed on the first mode of the first qubit and the second mode of the N^{th} qubit, and (ii) a beamsplitter interaction is performed on the second mode of the j^{th} qubit and the first mode of the (j+1)^{th} qubit for all j between 1 and N−1. The interferometer is arranged to output 2N optical modes. The detector arrangement includes one or more photodetectors to measure a photon occupation of each of the 2N output optical modes.

### CROSS-REFERENCE TO RELATED APPLICATION

This application claims priority to United Kingdom Application No. GB2301051.5, “Multi-qubit Entangling Measurements in Linear Optics,” filed on Jan. 25, 2023, which is hereby incorporated by reference in its entirety.

### TECHNICAL FIELD

The present disclosure relates to methods and apparatuses for performing measurements of photonic qubit states. In particular, but not exclusively, the present disclosure relates to apparatuses for performing an entangling measurement, and methods for entangling a plurality of multi-qubit photonic states.

### BACKGROUND

Various physical systems have been considered for quantum information processing. Many architectures rely on embodying information in matter-based systems such as ions or spin states in quantum dots. An alternative is linear optical quantum computing, in which information is encoded in electromagnetic field modes. Linear optical quantum computing uses linear optical elements such as beamsplitters and phase shifters to manipulate quantum information encoded in electromagnetic field modes. Photon detectors are used to process and read out information. Photonic platforms provide many advantages including the ability to facilitate quicker gate operations compared to the decoherence time of quantum information, fast read-out measurements, and efficient qubit transfer. Furthermore, photonic systems can largely operate at room temperature.

There are however some challenges in using linear optics to process quantum information, in particular (i) the lack of deterministic entangling operations and (ii) the impact of photon loss (due, for example, to absorption of leakage), and often these two challenges exacerbate one another. For example, one may be able to improve the theoretical probability of a successful entangling operation by increasing the number of optical elements involved, but each additional optical element may introduce further photon loss, and therefore information loss, into the system. These challenges increase the difficulty of reliably constructing large, entangled states, such as the highly entangled cluster states that are typically required for measurement-based quantum computing. Besides measurement-based quantum computing, these challenges also apply to building quantum networks that rely on the distribution of shared entangled states for applications such as quantum key distribution and entanglement enhanced quantum sensing.

It is an object of embodiments of this disclosure to at least mitigate one or more problems in the art.

### SUMMARY

According to an aspect of the present disclosure, an apparatus is provided. The apparatus comprises an optical circuit. The optical circuit comprises an interferometer arranged to receive, as 2N input optical modes, a plurality of N dual-rail encoded photonic qubits, each photonic qubit encoded as probability amplitudes corresponding to the photon occupation of two orthogonal optical modes, wherein N is an integer greater than two. The interferometer is further arranged to interfere the N dual-rail encoded photonic qubits such that (i) a beamsplitter interaction is performed on the first mode of the first qubit and the second mode of the N^{th} qubit, and (ii) a beamsplitter interaction is performed on the second mode of the j^{th} qubit and the first mode of the (j+1)^{th} qubit for all j between 1 and N−1, wherein j is an integer. The interferometer is further arranged to output 2N optical modes. The optical circuit further comprises a detector arrangement comprising one or more photodetectors, the detector arrangement configured to measure a photon occupation of each of the 2N output optical modes.

Advantageously, the apparatus enables a user to entangle multiple multi-qubit photonic states in one step. The apparatus further advantageously enables a user to generate large, entangled states from two-qubit resource states (e.g. Bell states)—for example, one is able to generate an N-qubit GHZ state from N Bell states in one go.

The apparatus may further comprise control circuitry for indicating, based on the measured photon occupation of the 2N output optical modes, that a N-qubit GHZ state measurement has been performed on the N qubits.

Measuring a photon occupation of a mode may comprise measuring the number of photons in that mode. The detector arrangement may comprise one or more photon number resolving (PNR) photodetectors.

Measuring a photon occupation of a mode may comprise measuring whether photons are present or absent from that mode. The detector arrangement may comprise one or more threshold photodetectors. Advantageously, threshold detectors are easier to implement than PNR detectors and are often operable at room temperature. Accordingly, as threshold detectors are compatible with the apparatuses described herein, the apparatuses are easier to build and maintain.

The detector arrangement may comprise one or more pseudo-threshold photodetectors, capable of determining whether 0, 1 or more than 1 photons have been received.

The apparatus may further comprise a second optical circuit configured to dual-rail encode the photonic qubits as 2N input optical modes.

The input optical modes and output optical modes may be spatial modes. Advantageously, for implementations of the apparatus in which the qubits are dual-rail encoded in spatial modes, each photon “sees” only one beamsplitter within the apparatus, which means there is a lower risk of detrimental photon loss. Furthermore, the apparatus may be implemented with N−1 beamsplitters coupling nearest-neighbour modes and a single beamsplitter coupling more distant modes, which can be easy to implement in a manifestly 3D platform using, for example, optical fibres.

The interferometer may comprise a spatial interferometer having 2N input ports for inputting the N dual-rail encoded qubits to the interferometer and 2N output ports for outputting the 2N output optical modes towards the detector arrangement.

The spatial interferometer may comprise a plurality of waveguides arranged to pass through the interferometer to connect the 2N input ports to the 2N output ports. The plurality of waveguides may be arranged to provide coupling locations between pairs of the plurality of waveguides, wherein a waveguide coupler is arranged at each of at least a subset of the coupling locations such that at each of those coupling locations the two optical modes carried by the two respective waveguides are capable of coupling with each other in a beamsplitter interaction.

In some examples, the interferometer is provided on a photonic integrated circuit.

The input optical modes and output optical modes may comprise temporal modes. By utilising temporal modes, the number of linear optical elements and detectors is advantageously reduced.

The interferometer may comprise a time bin interferometer. The time bin interferometer may comprise at least one temporal mode coupling device. In some examples, the temporal mode coupling device may comprise a reconfigurable beamsplitter and a delay line, the delay line configured to connect one input port of the reconfigurable beamsplitter with one output port of the reconfigurable beamsplitter. The apparatus may further comprise control circuitry for controlling the effective reflection coefficient of the reconfigurable beamsplitter. In some examples, the time bin interferometer may comprise at least one quantum memory device comprising an atomic system.

According to an aspect of the present disclosure, a method is provided for entangling a plurality of N photonic multiqubit states, wherein N is an integer greater than two. The method comprises performing a N-qubit GHZ state measurement on a subset of photonic qubits, the subset comprising one photonic qubit from each of the N photonic multiqubit states. Performing a N-qubit GHZ state measurement comprises dual-rail encoding each photonic qubit of the subset as probability amplitudes corresponding to the photon occupation of two orthogonal optical modes. Performing a N-qubit GHZ state measurement further comprises providing the dual-rail encoded photonic qubits to an interferometer, the interferometer configured to (i) perform a beamsplitter interaction is performed on the first mode of the first qubit and the second mode of the N^{th} qubit, and (ii) perform a beamsplitter interaction is performed on the second mode of the j^{th} qubit and the first mode of the (j+1)^{th} qubit for all j between 1 and N−1, wherein j is an integer. Performing a N-qubit GHZ state measurement further comprises measuring a photon occupation of all output modes from the interferometer.

Advantageously, the method enables a user to entangle multiple multi-qubit photonic states in one step. This is beneficial in several circumstances. For example, the method enables a generation of heralded, entangled resource states for fault-tolerant quantum computation and communication. In comparison to other known methods for generating heralded, entangled resource states, which typically involve performing Bell state measurements, the methods described herein lead to a significant increase in success probability, and a reduction in the linear optical circuit depth, multiplexing, and overall physical resources required for generating those heralded, entangled resource states.

The method further advantageously enables a user to generate large, entangled states from two-qubit resource states (e.g. Bell states)—for example, one is able to generate an N-qubit GHZ state from N Bell states in one go.

The method may further comprise, based on the measured photon occupation of the output modes, performing corrective operations on at least one unmeasured photonic qubit of the entangled state. For example, corrective operations may comprise one or more local operations.

In examples, at least one photonic multiqubit state may comprise a Bell state.

In examples at least one photonic multiqubit state may comprise a 3-qubit GHZ state.

In examples, the optical modes may comprise spatial modes.

Many modifications and other embodiments set out herein will come to mind to a person skilled in the art in light of the teachings presented herein. Therefore, it will be understood that the disclosure herein is not to be limited to the specific embodiments disclosed herein. Moreover, although the description provided herein provides example embodiments in the context of certain example combinations of elements, steps and/or functions, it will be appreciated that different combinations of elements, steps and/or functions may be provided by alternative embodiments without departing from the spirit or scope of the disclosure.

### BRIEF DESCRIPTION OF THE FIGURES

Illustrative embodiments of the present disclosure will now be described, by way of example only, with reference to the drawings. In the drawings:

FIG. 1A shows an illustration of an apparatus according to an example:

FIG. 1B shows a table of possible measurement outcomes that may be output from the apparatus of FIG. 1A and the input state that can be inferred from those outcomes:

FIG. 1C shows an illustration of an apparatus according to an example:

FIG. 1D shows an illustration of an apparatus according to an example:

FIG. 2A shows an illustration of an apparatus according to an example:

FIG. 2B shows an illustration of a temporal interferometer according to an example:

FIG. 2C illustrates the beamsplitter transmission coefficients and corresponding timings for configuring the apparatus of FIG. 2A using the interferometer of FIG. 2B to perform a 3-GHZ measurement; and

FIG. 3 shows a flowchart of a method for entangling a plurality of N photonic multiqubit states according to an example.

Throughout the description and the drawings, like reference numerals refer to like parts.

### DETAILED DESCRIPTION

Whilst various embodiments are described below, the disclosure is not limited to these embodiments, and the skilled person would appreciate that variations of these embodiments may be made without departing from the scope of the disclosure.

Just as a classical bit has a state—a computational basis state ( ) or a computational basis state 1—a quantum bit (a “qubit”) also has a state. A qubit may be in either of the computational basis states, in Dirac notation written as |0 [symbol] _{L} and |1 [symbol] _{L} respectively, or may be in a linear combination—a superposition—of those states e.g. |Ψ [symbol] =a|0 [symbol] _{L}+b|1 [symbol] _{L}. Abstractly, a qubit can be understood as a normalized vector in a two-dimensional Hilbert space. For the purposes of this document, such a qubit will often be referred to as a logical qubit, and the subscript L is used throughout this specification to denote a logical state. A measurement of the qubit in the computational basis will typically project the qubit onto either the 0 state or the 1 state with a probability dependent on the real or complex valued parameters a and b. A logical qubit may be realized using one or more physical qubits. Physical qubits are understood to mean physical quantum systems, the quantum properties of which can be interpreted as qubit states.

Many physical systems can be used to realize a physical qubit. Dynamically, quantum objects such as photons, electrons, ions and atoms obey the laws of quantum mechanics. In a physical quantum system, the quantum degrees of freedom within that physical quantum system are often referred to as modes. For example, a photonic system may be described by the spatial modes of the photonic system (which paths or superpositions of paths the photons within the photonic system take), the temporal modes of the photonic system (which time bins or superpositions of time bins the photons within the photonic system are in), the polarization modes of the photonic system (for example, whether the photons of the photonic system are horizontally polarized, vertically polarized, or some superposition of the two), the frequency modes of the photonic system (which frequencies or superpositions of frequencies the photons within the photonic system are in) or any intersection of these modes (for example, the quantum state of photons in a waveguide is often described in terms of spatiotemporal modes).

Photonic qubit states may be “dual-rail encoded”, which means that the logical value of a qubit can be expressed in terms of which of two modes a photon resides in. That is, the logical state of the qubit may be considered to be a computational basis state |0 [symbol] _{L} if the photon is in a first mode, while the logical state of the qubit may be considered to be a computational basis state |1 [symbol] _{L} if the photon is in a second mode orthogonal to the first mode. The logical state of the qubit may be described by a superposition state if the photon is in a superposition of the first and second modes. Without loss of generality, in the dual-rail encoding, the logical states |0 [symbol] _{L} and |1 [symbol] _{L} of a qubit can be expressed as:

$${\vert 0 〉}_{L} = \vert {1}_{1} , {0}_{2} 〉 \qquad ( EQ . 1 )$$

$${\vert 1 〉}_{L} = \vert {0}_{1} , {1}_{2} 〉 \qquad ( EQ . 2 )$$

where the subscripts 1 and 2 refer to first and second orthogonal modes respectively, and the corresponding 0 or 1 value represents the number of photons in that mode.

A beamsplitter is a four-port optical device, taking two optical modes as input and outputting two optical modes as output. In an ideal beamsplitter, the mode coupling is linear. Both input modes are partially transmitted and partially reflected by the beamsplitter. In an ideal beamsplitter, the total number of photons incident upon the beamsplitter at a point in time is conserved such that the number of photons output from the output ports is the same as the number of photons input on the input ports, but the photons are distributed between the two output modes in proportion to a transmission coefficient (or a reflection coefficient). The effect of a 50/50 beamsplitter on the dual-rail encoded computational basis states (EQ.1 and EQ.2) is, without loss of generality, taken to be:

$$BS \vert {1}_{1} , {0}_{2} 〉 \to \vert {1}_{1 ′} , {0}_{2 ′} 〉 + \vert {0}_{1 ′} , {1}_{2 ′} 〉 \qquad ( EQ . 3 )$$

$$BS \vert {0}_{1} , {1}_{2} 〉 \to \vert {1}_{1 ′} , {0}_{2 ′} 〉 - \vert {0}_{1 ′} , {1}_{2 ′} 〉 \qquad ( EQ . 4 )$$

up to normalization, where 1′ and 2′ indicate the first and second output modes of the beamsplitter. If two identical single photons are incident on a lossless 50/50 beamsplitter at the same time, one in each of two input modes of the beamsplitter, then due to interference the output modes become entangled. The output state can be expressed as a superposition of two configurations—one in which both photons are deflected to a first output mode and one in which both photons are deflected to the second output mode. The probability of the two photons being found in a particular one of the output modes is 50%. That is, up to normalisation, the effect of the 50/50 beamsplitter on two input modes carrying a single photon each is:

$$BS \vert {1}_{1} , {1}_{2} 〉 \to \vert {2}_{1 ′} , {0}_{2 ′} 〉 - \vert {0}_{1 ′} , {2}_{2 ′} 〉 \qquad ( EQ . 5 )$$

This effect is known as “photon bunching” and occurs even with imperfect 50/50 beamsplitters. The term “beamsplitter interaction” as used herein is understood to mean a mode coupling interaction that couples two input modes to two output modes in a same or similar manner to the way in which a beamsplitter would. A beamsplitter interaction (as used herein) accordingly may be imparted by a beamsplitter or by some other mechanism.

Two examples of entangled quantum states are the canonical N-qubit GHZ states (where N is an integer) defined (up to normalization) as:

$${{{\vert NGHZ \pm 〉}_{L} = \vert 0 〉}_{L}^{⊗ N} \pm \vert 1 〉}_{L}^{⊗ N} \qquad ( EQ . 6 )$$

where ⊗ indicates the Kronecker product. If one were to be provided with a large supply of N-qubit GHZ states of the form shown in (EQ. 6) and measure the state of each of the N qubits, then one would expect all N qubits to be in logical state ( ) around 50% of the time, and to be in logical state 1 around 50% of the time. States that are equivalent to the canonical N-qubit GHZ states of (EQ. 6) up to local (single qubit) Clifford rotations are also known as N-qubit GHZ states: any N-qubit GHZ state may be transformed to a canonical N-qubit GHZ state via a sequence of one or more local operations.

As used herein, to perform a “N-qubit GHZ measurement” is understood to mean projecting a multiqubit state onto an N-qubit GHZ state. Several examples of apparatuses capable of performing a N-qubit GHZ measurement are described herein.

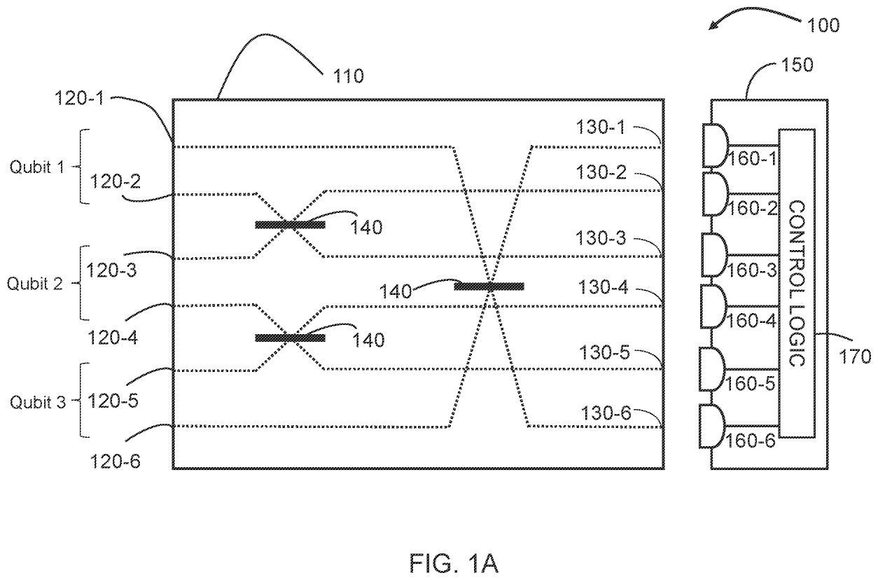

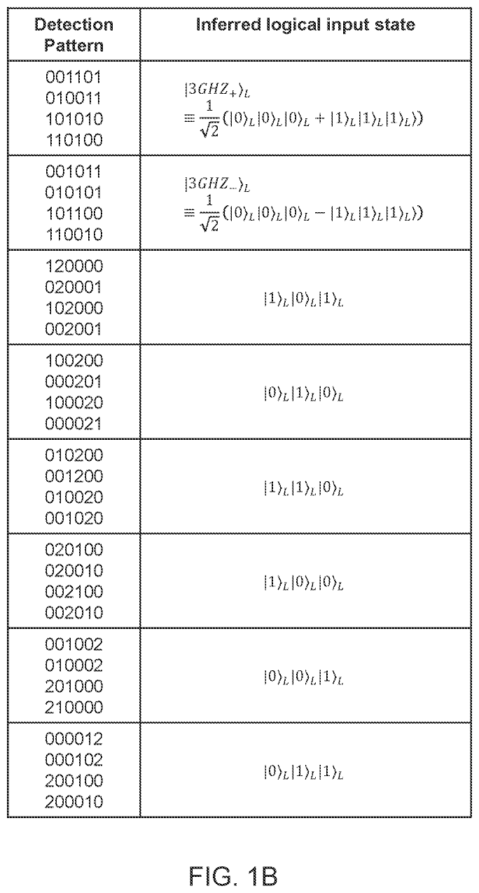

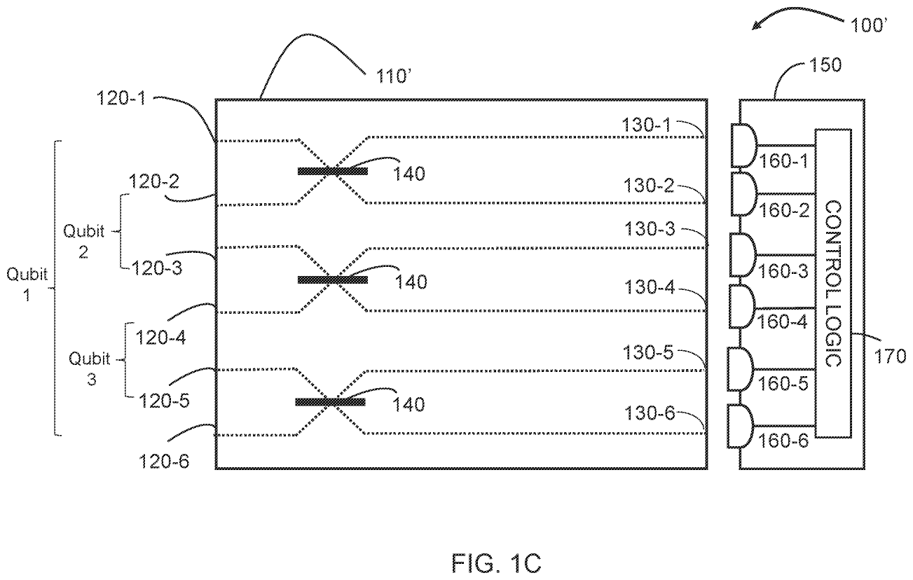

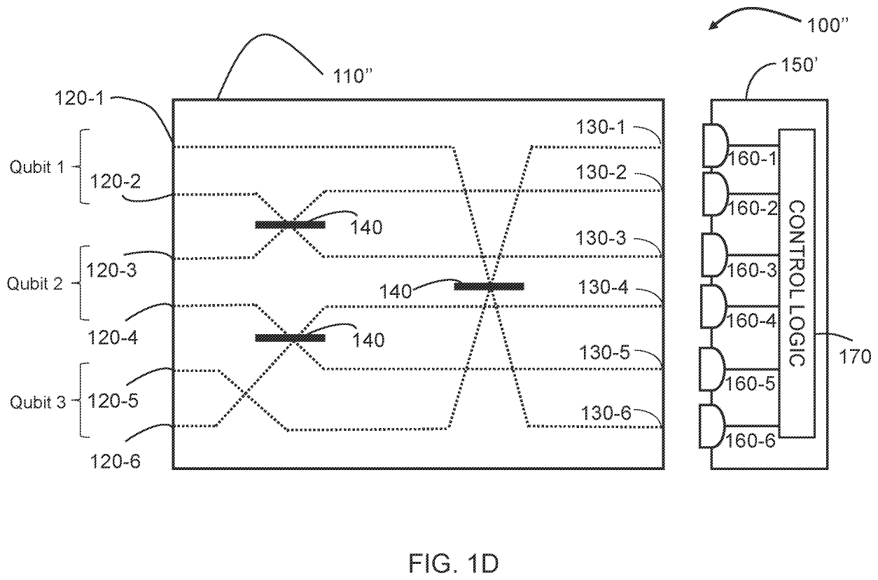

FIG. 1A illustrates an apparatus 100 according to an example. The skilled person will appreciate that other architectures would also be suitable. Apparatus 100 comprises an optical circuit comprising a spatial interferometer 110 and a detector arrangement 150. The skilled person will appreciate that while the spatial interferometer 110 and detector arrangement 150 are illustrated as separate entities in the figure, this is for illustration purposes only. The example apparatus 100 shown in FIG. 1A is suitable for probabilistically performing a 3-qubit GHZ measurement (that is, N=3), and the detection outcome indicates whether or not the measurement has been successful. The skilled person would appreciate that the same ideas can be used to perform an N-qubit GHZ measurement for an arbitrary number of qubits N.

The interferometer 110 of FIG. 1A is arranged to receive, as 2N (in this example, six) input optical modes, a plurality of N (in this example, three) dual-rail encoded photonic qubits, each photonic qubit encoded as probability amplitudes corresponding to the photon occupation of two optical modes. In this example, the input optical modes are spatial optical modes. The interferometer 110 accordingly comprises 2N input ports 120, labelled 120-1 to 120-6 in the figure. The first received qubit is defined by the photon occupation of the two optical paths immediately coupled to input ports 120-1 and 120-2: the second received qubit is defined by the photon occupation of the two optical paths immediately coupled to input ports 120-3 and 120-4; and the third received qubit is defined by the photon occupation of the two optical paths immediately coupled to input ports 120-5 and 120-6. For example, in accordance with (EQ. 1) the first received qubit may be in a logical ( ) state if a photon is received at input port 120-1 but not at 120-2, or in accordance with (EQ. 2) the first received qubit may be in a logical 1 state if a photon is received at input port 120-2 but not at 120-1.

The interferometer 110 further comprises 2N output ports 130, labelled 130-1 to 130-6 in the figure, for outputting the 2N output modes towards the detector arrangement 150. The interferometer 110 comprises a plurality of optical paths, shown as dotted lines in FIG. 1A, that are arranged to pass through the interferometer to connect the 2N input ports 120 to the 2N output ports 130. The plurality of optical paths are arranged so as to provide coupling locations between pairs of the plurality of optical paths. A 50/50 beamsplitter interaction, denoted by a beamsplitter 140 in the figure, occurs at each of the coupling locations such that at each coupling location the two optical modes carried by the two respective optical paths couple with one another in a beamsplitter interaction.

The interferometer 110 may be designed and manufactured in any suitable and desired way.

As a first example, the interferometer comprises (for example, is designed and manufactured using) an integrated circuit. The integrated circuit may be implemented in silicon nitride (Si₃N₄) or any other suitable material. The interferometer may comprise a plurality of etched waveguides to form the optical paths between the input ports and the output ports. The 50/50 beamsplitter interactions may be implemented by directional coupling, in which in a small coupling region two waveguides are situated close enough to one another that the evanescent fields between the two waveguides couple, the length of the coupling region and the separation of the waveguides chosen to provide a transmission coefficient of 50%. Crossing points at which no beamsplitter interaction is performed, for example such that the optical path from input port 120-1 can cross the optical paths from input ports 120-2 and 120-3 without interference, may be implemented by providing one or more of said optical paths at different depths within the substrate material of the integrated circuit. As an alternative, depending on how the detectors are deployed, the interferometer on the integrated circuit may be of a planar design, such that there are no crossing points at which no beamsplitter interaction is performed. As another alternative, while the apparatus is shown with input ports 120 on one side of the apparatus and detectors on the other, different geometries and form factors are equally applicable: for example, the apparatus may be configured in a circular or other geometry in which all detectors 160 are arranged in the interior of the device while all input ports 120 are arranged around the exterior of the apparatus.

In a second example, the interferometer may be implemented in bulk optics, with optical paths provided in free space or optical fibre, and beamsplitter interactions provided by beamsplitters. Optical fibre may advantageously enable reliable “long-distance” interactions such as that between the first input port 120-1 and sixth input port 120-6 (in contrast the nearest-neighbouring waveguide interactions between e.g. second input port 120-2 and third input port 120-3 may be thought of as “short distance” in comparison.

The detector arrangement 150) comprises 2N photodetectors which in FIG. 1A are labelled 160-1, to 160-6 in correspondence to the output ports 130-1 to 130-6 to which they are respectively aligned. In some examples, the photodetectors may comprise photon number resolving (PNR) detectors, capable of determining how many photons are received. For example, the detectors may comprise superconducting nanowire detectors that generate an output signal intensity proportional to the (discrete) number of photons that strike a detector. The PNR detectors may comprise transition edge sensors (TESs). In other examples, the photodetectors may comprise threshold detectors, also known as on/off detectors. Threshold detectors are not capable of determining how many photons are received but are capable of determining the presence/absence of photons in an output mode. In other examples, the photodetectors may comprise pseudo-threshold detectors, capable of determining if zero, one, or more than one photon is received. The choice of detector may depend on the form factor of the apparatus.

The skilled person will appreciate that the interferometer and detectors may be connected in any of a number of ways. For example, the detectors may be implemented on-chip with the interferometer. For example, the output ports 130 may be coupled to the detectors with optical fibres.

The apparatus 100 further comprises control logic 170. The control logic 170 is configured to receive detection signals from the photodetectors 160, for example electrical signals indicative of a number of photons incident on each detector at a particular point in time or within a particular time window. The control logic 170 is further configured to determine whether or not an N-qubit GHZ measurement has successfully been performed. In other words, the control logic 170 is further configured to determine whether or not the detection signals from the photodetectors 160 imply that the photon configuration input into the interferometer 110 correspond to an N-qubit GHZ (in this example 3-qubit GHZ) state. The control logic 170 is further configured to, in the event that a N-qubit GHZ measurement is successfully performed, provide an indication that the N-qubit GHZ measurement was successfully performed. In some examples, the control logic 170 may generate an output signal (electrical, audible, visual or otherwise) only when the detection signals imply that the photon configuration input into the interferometer correspond to an N-qubit GHZ state. In other examples, the control logic may generate an output signal for each point in time/time window in which detection signals are collected, and that output signal may contain information indicating whether or not an N-qubit GHZ measurement was performed successfully at that point in time/within that time window.

The control logic 170 may be implemented in a hardware controller. In some examples, the controller may be a general or dedicated processor, such as a central processing unit (CPU) or a graphics processing unit (GPU). In other examples, the controller may be implemented in a dedicated, application-specific processing unit. For example, the controller may comprise an application-specific integrated circuit (ASIC) or an application-specific standard product (ASSP) or another domain-specific architecture (DSA). Alternatively, the controller may be implemented in adaptive computing hardware (that is, hardware comprising configurable hardware blocks/configurable logic blocks) that has been configured to perform the required functions, for example in a configured field programmable gate array (FPGA).

The arrangement of the coupling locations and beamsplitters 140 is such that interferometer 110 is configured to interfere the N dual-rail encoded photonic qubits such that (i) a beamsplitter interaction is performed on the second mode of the j^{th} qubit and the first mode of the (j+1)^{th} qubit for all j between 1 and N−1, wherein j is an integer, and (ii) a beamsplitter interaction is performed on the first mode of the first qubit and the second mode of the N^{th} qubit. Accordingly, in FIG. 1A, a first 50/50 beamsplitter 140 is arranged to interfere the second mode (received in input port 120-2) of the first qubit and the first mode (received in input port 120-3) of the second qubit: a second 50/50 beamsplitter 140 is arranged to interfere the second mode (received in input port 120-4) of the second qubit and the first mode (received in input port 120-5) of the third qubit; and a third 50/50 beamsplitter 140 is arranged to interfere the first mode (received in input port 120-1) of the first qubit with the second mode (received in input port 120-6) of the third qubit.

Consider, for example, the logical input product state:

$${\vert 0 〉}_{L}^{⊗ 3} = \vert {1}_{1} , {0}_{2} 〉 \vert {1}_{3} , {0}_{4} 〉 \vert {1}_{5} , {0}_{6} 〉 \qquad ( EQ . 7 )$$

in which the subscripts on the right-hand side indicate a corresponding spatial channel (input port 120). That is, the first dual-rail encoded qubit is in logical state ( ) and so is encoded as a single photon entering first input port 120-1 and zero photons entering second input port 120-2; the second dual-rail encoded qubit is in logical state ( ) and so is encoded as a single photon entering third input port 120-3 and zero photons entering fourth input port 120-4; and the third dual-rail encoded qubit is in logical state 0 and so is encoded as a single photon entering fifth input port 120-5 and zero photons entering sixth input port 120-6. At the output of the interferometer 110, the resulting state is given (up to normalisation) by:

$$\vert {1}_{1 ′} , {1}_{2 ′} , {0}_{3 ′} , {1}_{4 ′} , {0}_{5 ′} , {0}_{6 ′} 〉 - \vert {1}_{1 ′} , {1}_{2 ′} , {0}_{3 ′} , {0}_{4 ′} , {1}_{5 ′} , {0}_{6 ′} 〉 - \vert {1}_{1 ′} , {0}_{2 ′} , {1}_{3 ′} , {1}_{4 ′} , {0}_{5 ′} , {0}_{6 ′} 〉 + \vert {1}_{1 ′} , {0}_{2 ′} , {1}_{3 ′} , {0}_{4 ′} , {1}_{5 ′} , {0}_{6 ′} 〉 + \vert {0}_{1 ′} , {1}_{2 ′} , {0}_{3 ′} , {1}_{4 ′} , {0}_{5 ′} , {1}_{6 ′} 〉 - \vert {0}_{1 ′} , {1}_{2 ′} , {0}_{3 ′} , {0}_{4 ′} , {1}_{5 ′} , {1}_{6 ′} 〉 - \vert {0}_{1 ′} , {0}_{2 ′} , {1}_{3 ′} , {1}_{4 ′} , {0}_{5 ′} , {1}_{6 ′} 〉 + \vert {0}_{1 ′} , {0}_{2 ′} , {1}_{3 ′} , {0}_{4 ′} , {1}_{5 ′} , {1}_{6 ′} 〉$$

in which the subscripts on the right-hand side indicate a corresponding spatial channel (output port 130). Next consider, the effect of the interferometer 110 on the complementary logical input state:

$${\vert 1 〉}_{L}^{⊗ 3} = \vert {0}_{1} , {1}_{2} 〉 \vert {0}_{3} , {1}_{4} 〉 \vert {0}_{5} , {1}_{6} 〉 \qquad ( EQ . 7 )$$

which becomes (up to normalisation):

$$\vert {1}_{1 ′} , {1}_{2 ′} , {0}_{3 ′} , {1}_{4 ′} , {0}_{5 ′} , {0}_{6 ′} 〉 + \vert {1}_{1 ′} , {1}_{2 ′} , {0}_{3 ′} , {0}_{4 ′} , {1}_{5 ′} , {0}_{6 ′} 〉 + \vert {1}_{1 ′} , {0}_{2 ′} , {1}_{3 ′} , {1}_{4 ′} , {0}_{5 ′} , {0}_{6 ′} 〉 + \vert {1}_{1 ′} , {0}_{2 ′} , {1}_{3 ′} , {0}_{4 ′} , {1}_{5 ′} , {0}_{6 ′} 〉 - \vert {0}_{1 ′} , {1}_{2 ′} , {0}_{3 ′} , {1}_{4 ′} , {0}_{5 ′} , {1}_{6 ′} 〉 - \vert {0}_{1 ′} , {1}_{2 ′} , {0}_{3 ′} , {0}_{4 ′} , {1}_{5 ′} , {1}_{6 ′} 〉 - \vert {0}_{1 ′} , {0}_{2 ′} , {1}_{3 ′} , {1}_{4 ′} , {0}_{5 ′} , {1}_{6 ′} 〉 - \vert {0}_{1 ′} , {0}_{2 ′} , {1}_{3 ′} , {0}_{4 ′} , {1}_{5 ′} , {1}_{6 ′} 〉 .$$

A property of the two input states of (EQ.7) and (EQ. 8) is that any pair of neighbouring input ports receives only one photon, and these are the only input states for which this property holds. If one considers any other input state to the interferometer 110, at least one pair of neighbouring input ports receives two photons and the beamsplitter interaction will result in a state in which both of the photons are in the same mode. The input states given in (EQ. 7) and (EQ. 8) are the only two input states that have any overlap in their detection patterns. Accordingly, if the photodetectors 160-1 to 160-6 measure certain outcomes, then this corresponds to a measurement of a 3-qubit GHZ state. This property holds if the apparatus is extended to N qubits.

The left-hand column of FIG. 1B shows the measurement outcomes that may be produced by the photodetectors 160-1 to 160-6 in response to the apparatus 100 receiving a three-qubit dual-rail encoded state formed of three photons. For example, “210000” indicates that detector 160-1 detected two photons, photodetector 160-2 detected one photon, and photodetectors 160-3 to 160-6 each did not detect any photons. The right-hand column of FIG. 1B indicates the input state that can be inferred by the control logic 170 to have been measured by the apparatus 100, based on the photodetectors 160-1 to 160-6 measuring a corresponding outcome indicated in the left hand column. For example, if photodetectors 160-1, 160-2 and 160-4 each detect one photon, then the controller 170 is able to infer that the logical input state that was measured by the apparatus was a 3-qubit GHZ state and in particular the canonical 3 GHZ+ state (see EQ. 6).

As indicated in the table of FIG. 1B, the apparatus 100 performs an equal-weight projection on to the canonical 3 GHZ+ and 3 GHZ− states and each of the separable states indicated in the table, and each inferred state is associated with four different detection patterns. The control logic 170 may be configured to indicate, for example with an output signal, whether a 3-qubit GHZ state was detected or not. The control logic 170 may be configured to indicate, for example with an output signal, which 3-qubit GHZ state was detected. The control logic 170 may be configured to indicate when a N-qubit GHZ measurement has not been successfully performed, for example when a detection outcome indicates that the input state has been projected onto a product state.

The skilled person will appreciate that the apparatus 100 may be varied in many ways. For example, while FIG. 1A depicts optical paths of the interferometer 110 crossing at many locations in order to give effect to all of the beamsplitter interactions, this need not be the case. For example, and as indicated in FIG. 1C (depicting apparatus 100′ including interferometer 110′), a routing device (not shown) may be used to route the first mode of the first qubit to an input port adjacent to the second mode of the N^{th} qubit. In this way, crossing points can be reduced (e.g., minimised). In some architectures, for example when the interferometer 110′ is implemented in a planar integrated circuit, there is a chance of photon loss at crossing points, and so advantageously by reducing the number of crossing points, the accuracy of the apparatus may be improved.

In other variations, the interferometer may be configured to perform one or more single qubit transformations. For example, while the interferometer 110 of FIG. 1A is configured such that a detection pattern indicates whether or not a projection onto a canonical GHZ state has occurred, the interferometer 110″ of the apparatus 100″ shown in FIG. 1D is configured such that a detection pattern indicates whether or not a projection onto a different GHZ state has occurred, more particularly the GHZ states:

$${{{{{{\vert 0 〉}_{L} \vert 0 〉}_{L} \vert 1 〉}_{L} \pm \vert 1 〉}_{L} \vert 1 〉}_{L} \vert 0 〉}_{L}$$

The interferometer 110″ of FIG. 1D is similar to that of FIG. 1A except that the optical paths coupled to the fifth and sixth input ports 120-5 and 120-6 are swapped such that any photons entering input port 120-6 couple with any photons entering port 120-4, and any photons entering port 120-5 couple with any photons entering port 120-1. The skilled person would appreciate that the interferometer may be configured to perform other single qubit operations.

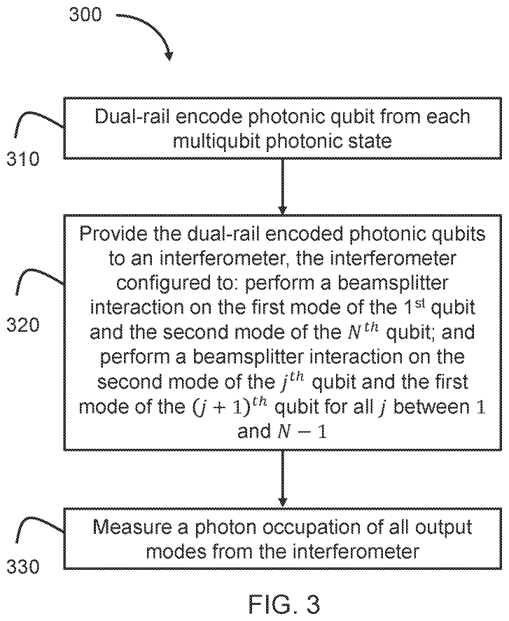

The apparatuses of FIG. 1A, FIG. 1C and FIG. 1D each provide depth-1 circuits for measuring N-qubit GHZ states. In other words, each photon sees at most a single beamsplitter before detection. Photon loss is a large source of errors in photonic systems and accordingly a depth-1 circuit means that photon loss is reduced (e.g., minimal). As will be described further below in relation to FIG. 3, such a low depth apparatus for performing N-GHZ measurements can be used to produce larger entangled states using only depth-1 optical circuits, which can be useful for applications such as generating resource states for measurement-based quantum computation in a low loss manner.

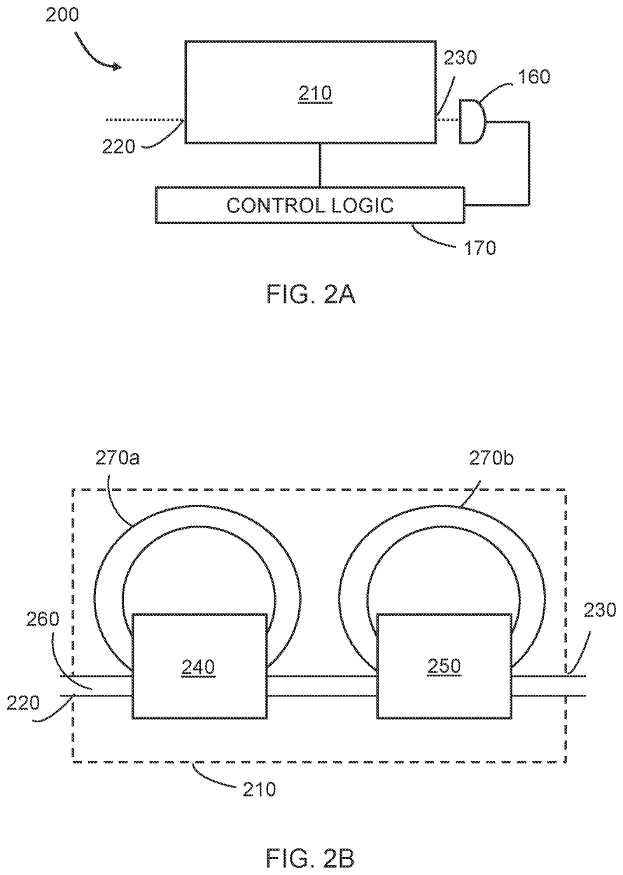

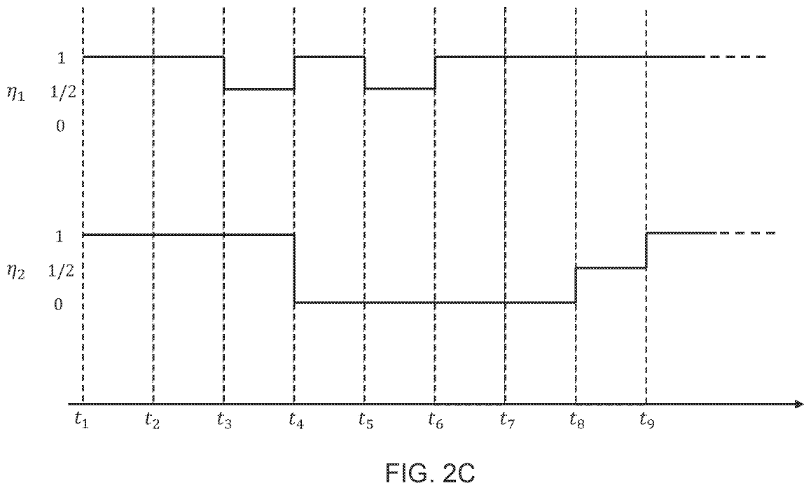

FIG. 2A shows an illustration of an example apparatus 200. Apparatus 200 comprises an optical circuit comprising a time bin interferometer 210 and a detector arrangement comprising a single threshold detector 160. Photonic qubits are encoded into temporal modes or time bins. Analogous to the input modes of a spatial interferometer, the time bins in which single photons may be found indicate a logical state. For example, a first dual-rail encoded qubit in logical state 0 is encoded as a single photon provided in a first time bin and zero photons in a second (subsequent) time bin. A second dual-rail encoded qubit in logical state 1 may be encoded as zero photons provided in a third time bin (subsequent to the second time bin) and a single photon provided in a fourth time bin (subsequent to the third time bin). In this way, an N qubit state may be encoded in 2N time bins each of duration T. In the apparatus 200 photons may be received via a single input port 220 to the time bin interferometer 210. The time bin interferometer 210 may be controlled so as to interfere photons in different time bins, thereby entangling those temporal modes. Photons may exit the time bin interferometer 210 via a single output port 230 to be detected by the threshold detector 160 capable of detecting the presence or absence of photons in each time bin.

Apparatus 200 further comprises control logic 170. The control logic 170 may be implemented in a hardware controller and may have any of the properties described above in relation to the control logic of FIG. 1A. The control logic 170 is configured to receive detection signals from the detector 160 and to determine, from the presence or absence of photons in each time bin, whether or not an N-qubit GHZ measurement has been performed. The controller is further configured to provide an indication when an N-qubit GHZ measurement has been successfully performed. Additionally, the controller 170 is configured to control the time bin interferometer in order to control the interference of time bins.

FIG. 2B shows an example of a time bin interferometer comprising two temporal mode coupling devices. The first temporal mode coupling device comprises a first reconfigurable photonic device 240 and first delay line 270a. The second temporal mode coupling device comprises a second reconfigurable photonic device 250 and a second delay line 270b.

The first reconfigurable photonic device 240) (also “reconfigurable beamsplitter 240”) has two input ports and two output ports and is configured to controllably interfere photons received at substantially the same time through the two input ports based on one or more control signals received from the control logic 170 (two photons are understood to be received at substantially the same time if the wave packets of those photons overlap). That is, the first reconfigurable beamsplitter 240 has a tuneable effective transmission coefficient (or conversely, a tuneable effective reflection coefficient). The first delay line 270a is arranged to couple a first output port of the first reconfigurable beamsplitter 240 to a first input port of the first reconfigurable beamsplitter 240. The first delay line 270a may be implemented using optical fibre. The length of the first delay line 270a is designed to delay light by an amount of time T equal to the duration of a time bin. Accordingly, the first reconfigurable beamsplitter 240) may be controlled to interfere an optical mode received from the first delay line 270a with an optical mode received from the input 220 along optical fibre 260. The second output port of the first reconfigurable beamsplitter 240 is arranged to output optical modes along an optical path 260 towards the second temporal mode coupling device.

The first reconfigurable beamsplitter 240 may be implemented in any suitable way, for example as a Mach-Zehnder interferometer. For example, a Mach-Zehnder interferometer may comprise two 50:50 beamsplitters with a reconfigurable thermo-optic phase shifter on one internal path between the two 50:50 beamsplitters. Optionally, a further phase shifter may be arranged on an external path (input or output) of a Mach-Zehnder interferometer. By tuning the phase shifter(s), the effective transmission coefficient of the Mach-Zehnder interferometer is reconfigurable.

The second temporal mode coupling device comprises a second reconfigurable beamsplitter 250, and a second delay line 270b connecting a first output port of the second reconfigurable beamsplitter 250 to a first input port of the second reconfigurable beamsplitter. The second delay line 270b in this example also has a length designed to delay light by an amount of time T equal to the duration of a time bin. The second reconfigurable beamsplitter 250 may be of a similar design to the first reconfigurable beamsplitter 240, or may be implemented differently.

The time bin interferometer of FIG. 2B can be used to implement a similar interference transformation to the interferometer of FIG. 1A, as will now be explained in an example. A timing diagram for the transmission coefficients of the first reconfigurable beamsplitter 240 (η₁) and the second reconfigurable beamsplitter 250 η₂ is shown in FIG. 2C. In the timing diagram of FIG. 2C it is assumed that the length of the first delay path 270a, the length of the second delay path 270b and the length of the optical path between the second output of the first reconfigurable beamsplitter and the second reconfigurable beamsplitter are each designed to be equal to the duration T of a time bin.

Consider three photonic qubits dual-rail encoded in six consecutive time bins. Initially, the controller 170 configures the first reconfigurable beamsplitter 240 to be fully transmissive (transmission coefficient η₁=1) such that any photons received from the optical fibre 260 at the second input port to the first reconfigurable beamsplitter 240 are routed into the first delay line 270a and photons received from the first input port to the first reconfigurable beamsplitter 240) are routed towards the second temporal mode coupling device. Accordingly, at a first time instance (t₁), at which the beginning of a first time bin arrives at the first reconfigurable beamsplitter 240, any photon in that first time bin is routed into the first delay line 270a.

At the second time instance (t₂), at which the beginning of a second time bin arrives at the first reconfigurable beamsplitter 240, the transmission coefficient of the first reconfigurable beamsplitter 240 is maintained. Accordingly, any photon in the second time bin is routed into the first delay line 270a and any photon of the first time bin (previously routed into the first delay line 270a) is routed out of the first delay line 270a towards the second temporal mode coupling device.

The controller 170 next configures the reconfigurable beamsplitter 240 to have 50% transmittivity (transmission coefficient η₁=½). Accordingly, in the third time instance (t₃), the second time bin in delay line 270a and the third time bin in optical fibre 260 are incident on the first reconfigurable beamsplitter 240 at the same time (or substantially the same time) and any photons in those time bins interfere on the reconfigurable beamsplitter 240. A first output mode of the first reconfigurable beamsplitter 240 is routed from the first output port of the reconfigurable beamsplitter 240 into the first delay line 270a, while the second output mode is routed towards the second temporal mode coupling device. Meanwhile, the second reconfigurable beamsplitter 250 is configured to be fully transmissive such that any photons received from the first temporal mode coupling device at the second input port to the second reconfigurable beamsplitter 250 are routed into the second delay line 270b and photons received from the first input port to the second reconfigurable beamsplitter 250 are routed towards the interferometer output port 230. As the first time bin reaches the second reconfigurable beamsplitter 250, it is routed into the second delay line 270b.

At the fourth time instance (t₄), the first reconfigurable beamsplitter 240 is controlled to be fully transmissive (η₁=1) and the second reconfigurable beamsplitter 250 is controlled to be fully reflective (η₂=0). Accordingly, any photons in the first delay line 270a are routed towards the second temporal mode coupling device, while the fourth time bin is routed into the first delay line 270a. Meanwhile, as the second time bin reaches the second reconfigurable beamsplitter 250, it is routed towards the detector arrangement bypassing the second delay line 270b.

At the fifth time instance (t₅), the first reconfigurable beamsplitter 240 is controlled to have 50/50 transmittivity (η₁=½). Accordingly, the fourth time bin (in the first delay line 270a) and the fifth time bin interfere on the first reconfigurable beamsplitter.

At the sixth time instance (t₆), the first reconfigurable beamsplitter 240 is controlled to have 100% transmittivity (η₁=1). Accordingly, any photons in the first delay line 270a are routed towards the second temporal mode coupling device, while the sixth time bin is routed into the first delay line 270a. At the seventh time instance (t₇), the transmittivity of the first reconfigurable beamsplitter is maintained and the sixth time bin exits the first delay line 270a towards the second temporal mode coupling device.

At the eighth time instance (t₈), the second reconfigurable beamsplitter is controlled to have 50% transmittivity. Accordingly, any photons in the second delay line 270b (i.e. any photons that were in the first time bin) interfere with any photons in the sixth time bin. At the ninth time instance (t₉), the second reconfigurable beamsplitter is controlled to have 100% transmittivity. Accordingly, any photons routed into the second delay line 270b at time instance t₈ are routed out of the time bin interferometer towards the detector arrangement.

The photodetector 160 is arranged the receive photons output from the output port 230 and to indicate if and when photons have been received. From the indication(s), the control logic 170 is able to determine to which output time bin a detection event corresponds and accordingly to determine whether an N-GHZ measurement has been performed.

While in the discussion above, a temporal mode coupling device comprises a delay line and a reconfigurable beamsplitter, the skilled person would appreciate that other architectures are suitable for interfering temporal modes. A temporal mode coupling device may comprise, for example, a quantum memory device comprising an atomic system having discrete energy states. The atomic system may comprise a single type of neutral atoms or ions or a plurality of different types of neutral atoms and/or ions. The atomic system may be an atomic ensemble comprising a plurality of atoms, such as a gas of atoms, or ions, such as a rare earth ion locked in a host medium. Such an atomic system may use energy levels associated with electrons in inner or outer shells of atoms, ions, or crystal defects. Examples of suitable atomic ensembles include vapours containing Rubidium. Other energy levels of atomic system may be used including Rydberg—type atomic systems. Additionally, or alternatively the atomic system may comprise a single neutral atom or ion, for example single 87Rb atoms in a magneto-optical-trap (MOT). The quantum memory device may be used to controllably place, for example, a photon in the first temporal mode into a superposition of being stored in the memory and being not stored in the memory, and then to controllably release any photon (or quantum state thereof) stored in the memory at the time the second temporal mode passes through, in order to interfere temporal modes in a similar way as a reconfigurable beamsplitter can be used to interfere modes. Additionally, an example of a suitable quantum memory device being used in such a way is described in international patent application number PCT/GB2021/052447 filed on 21 Sep. 2021 in the name of ORCA Computing Limited, the content of which is incorporated herein by reference.

In the discussions above, measurement apparatuses have been described that are capable of performing an N-qubit GHZ measurement. A useful application for performing a N-qubit GHZ measurement is in entangling a plurality of N photonic multiqubit states.

FIG. 3 shows a flowchart of a method 300 for entangling a plurality of N photonic multiqubit states, wherein N is an integer. The method comprises performing an N-qubit GHZ measurement on a subset of photonic qubits, the subset comprising one photonic qubit from each of the N photonic multiqubit states.

At 310, the method comprises dual-rail encoding each photonic qubit of the subset as probability amplitudes corresponding to the photon occupation of two orthogonal optical modes. For example, with reference to the apparatus 100 of FIG. 1A, each of the qubits may be dual-rail encoded in the input ports to which the photonic qubit is provided.

At 320, the method comprises providing the dual-rail encoded photonic qubits to an interferometer, the interferometer configured to (i) perform a 50/50 beamsplitter interaction on the first mode of the first qubit and the second mode of the N^{th} qubit; and (ii) perform a 50/50 beamsplitter interaction on the second mode of the j^{th} qubit and the first mode of the (j+1)^{th} qubit for all j between 1 and N−1, wherein j is an integer. For example, with reference to the apparatus 100 of FIG. 1A. 50/50 beamsplitter interactions are performed between the first mode of the first qubit and the second mode of the third qubit, between the second mode of the first qubit and the first mode of the second qubit, and between the second mode of the second qubit and first mode of the third qubit.

At 330, the method comprises measuring a photon occupation of all output modes from the interferometer to determine whether a N-qubit GHZ measurement has been performed. For example, with reference to the apparatus 100, the photodetectors 160 are arranged to measure the number of photons in each output mode. From the measurement outcome, the control logic 170 is able to confirm that a projection of the output state of the interferometer 110 on to a 3-GHZ state has been performed. By projecting the output modes onto an N-qubit GHZ state, the remaining qubits of the photonic multiqubit photonic states are entangled.

An example of a use case for linear-optics based measurement apparatuses and methods such as those described herein is in the generation of large, heralded entangled states, which find use in, for example, measurement-based quantum computing.

In a typical approach to generating large, heralded entangled states, a large number of low-level few-qubit photonic entangled resource states (for example, photonic 3-qubit GHZ states) are generated. Bell state measurements, in which an input state is probabilistically projected onto a two-qubit Bell state, are then used to entangle pairs of those few-qubit resource states to generate slightly larger entangled states—for example, a Bell state measurement can be used to probabilistically entangle two 3-qubit GHZ states to create a 4-qubit GHZ state. A figure of merit often used to evaluate linear optical Bell state measurements is the success probability—the probability that a maximally mixed input state is projected onto a known Bell state. For linear optical schemes that do not take advantage of auxiliary qubits, the optimal success probability of an individual Bell state measurement is known to be ½ (one half). Successive Bell state measurements may then be used to build larger entangled states. For example, an N-qubit GHZ state is typically created by combining two smaller GHZ states using a Bell state measurement. With Bell state measurements, the generation of an N-qubit GHZ state can accordingly be broken down into 3-qubit GHZ states and a binary tree of Bell state measurements, the binary tree having a depth of [log₂(N−2)]. This means that the probability of successfully generating a N-qubit GHZ state using Bell state measurements is given by 2^{-2[log}^{₂}^{(N-2)]} Moreover, using only Bell state measurements, the minimal resource states that are required must contain at least three entangled qubits, for example, a 3-qubit GHZ state, which may also only be probabilistically generated. The use of Bell state measurements to entangle resource states means that the initial low-level resource states cannot themselves be Bell states as the low-level resource states must comprise at least three qubits.

In contrast, the apparatuses and methods described herein can be used to generate larger resource states from more basic two-qubit entangled states such as Bell states. Bell states are a viable and easier-to-generate candidate for the low-level resource states than three-qubit GHZ states. For example, consider a number N of Bell states. Labelling each pair with the superscript (j), where j is an integer between 1 and N, and labelling the qubits in each pair with A and B, the initial state of the system of N Bell pairs can be written as:

$${{{\vert {Ψ}^{A B} 〉}_{L} = \frac{1}{{2}^{N / 2}} {⊗}_{j = 1}^{N} [ {\sum }_{{x}_{j} = 0 , 1} \vert {x}_{j} 〉}_{L}^{( j ) , A} \vert {x}_{j} 〉}_{L}^{( j ) , B} ] \qquad ( EQ . 9 )$$

A subset of the qubits, in this example comprising one qubit of each Bell state (for example those labelled A), are then dual rail encoded and provided to an interferometer such as that shown in FIG. 1A. The interferometer is arranged to perform a 50/50 beamsplitter interaction on the first mode of the first qubit and the second mode of the N^{th} qubit and to perform a 50/50 beamsplitter interaction on the second mode of the j^{th} qubit and the first mode of the (j+1)^{th} qubit for all j between 1 and N−1.

Upon performing an N-qubit GHZ measurement on those qubits, the remaining qubits (labelled B) are placed into (unnormalized) state:

$${{\vert {Φ}^{B} 〉}_{L} = {〈 NGHZ \pm \vert {Ψ}^{A B} 〉}_{L} = \frac{1}{{2}^{\frac{N}{2}}} \vert NGHZ \pm 〉}_{L} \qquad ( EQ . 10 )$$

As indicated in (EQ. 10) the remaining qubits of the multiqubit photonic states are projected onto an entangled state which in this example is one of the two canonical N-qubit GHZ states that the apparatus 100 is capable of measuring. The probability of obtaining each of the canonical GHZ states is equal to the magnitude squared of the projection which is equal to:

$$p ( NGHZ \pm ) = \frac{1}{{2}^{N}} \qquad ( EQ . 11 )$$

and the measurement outcome provided by the detectors 160 indicates which of the entangled states has been generated.

Accordingly, the probability of entangling the plurality of N photonic multiqubit states scales with N as:

$$p ( Entangling ) = \frac{1}{{2}^{N - 1}} . \qquad ( EQ . 12 )$$

The skilled person will appreciate that the method 300 of FIG. 3 may be varied or extended in a number of ways. For example, the method may further comprise performing one or more corrective operations on one or more of the qubits of the resulting entangled state. For example, if control logic 170 indicates that a projection onto the canonical NGHZ− state has been performed, and so the resulting entangled state is in the NGHZ− state then a Pauli-Z operation may be performed on any qubit of that resulting state may be performed, for example using an optical phase shifter on one mode of a dual rail encoding of that qubit, to transform that resulting state to a NGHZ+ state.

As indicated above, the methods and apparatuses described herein accordingly enable the generation of large, entangled states such as N-qubit GHZ states using more basic resource states than 3-GHZ states, for example 2-qubit Bell states.

Even if one chooses to use 3-qubit GHZ states as the most basic resource state in creating a N-qubit GHZ state, then further advantages are apparent when compared to the typical approach of building an N-qubit GHZ state using 3-qubit GHZ states and Bell state measurements. Using the method 300, a N-qubit GHZ state can be generated by combining [N/2] 3-qubit GHZ states using a single [N/2]-qubit GHZ measurement and has a success probability of 2^{-[(N/2)-1]}. Furthermore, since the dual-rail encoded N-qubit GHZ measurements described herein (at least when spatial modes are considered) are depth-1 in beamsplitters, there is a quadratic reduction in the overall number of initial 3-qubit GHZ states required to achieve a fixed multiplexed success probability.

Variations of the described embodiments are envisaged.

All of the features disclosed in this specification (including any accompanying claims, abstract and drawings, and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of any foregoing embodiments. The disclosure extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

What is claimed is:

1. An apparatus comprising:
an optical circuit comprising:
an interferometer arranged to:
receive, as 2N input optical modes, a plurality of N dual-rail encoded photonic qubits, each photonic qubit encoded as probability amplitudes corresponding to the photon occupation of two orthogonal optical modes, wherein N is an integer greater than two:
interfere the N dual-rail encoded photonic qubits via beamsplitter interactions, the beamsplitter interactions comprising:
a beamsplitter interaction on the first mode of the first qubit and the second mode of the N^{th} qubit; and
a beamsplitter interaction on the second mode of the j^{th} qubit and the first mode of the (j+1)^{th} qubit for all j between 1 and N−1, wherein j is an integer; and
output 2N optical modes; and
a detector arrangement comprising one or more photodetectors, the detector arrangement configured to measure a photon occupation of each of the 2N output optical modes.

2. The apparatus according to claim 1, further comprising control circuitry for indicating, based on the measured photon occupation of the 2N output optical modes, that a N-qubit GHZ state measurement has been performed on the N qubits.

3. The apparatus according to claim 1, wherein the detector arrangement comprises one or more photon number resolving photodetectors.

4. The apparatus according to claim 1, wherein the detector arrangement comprises one or more threshold photodetectors.

5. The apparatus according to claim 1, further comprising a second optical circuit configured to dual-rail encode the photonic qubits as 2N input optical modes.

6. The apparatus according to claim 1, wherein the input optical modes and output optical modes are spatial modes.

7. The apparatus according to claim 6, wherein the interferometer is a spatial interferometer including 2N input ports for inputting the N dual-rail encoded qubits to the interferometer and further including 2N output ports for outputting the 2N output optical modes towards the detector arrangement.

8. The apparatus according to claim 7,
wherein the spatial interferometer comprises a plurality of waveguides arranged to pass through the interferometer to connect the 2N input ports to the 2N output ports;
wherein the plurality of waveguides are arranged to provide coupling locations between pairs of the plurality of waveguides, wherein a waveguide coupler is arranged at each of at least a subset of the coupling locations such that at each of those coupling locations the two optical modes carried by the two respective waveguides are capable of coupling with each other in a beamsplitter interaction.

9. The apparatus according to claim 1, wherein at least the interferometer is provided on a photonic integrated circuit.

10. The apparatus according to claim 1, wherein the input optical modes and output optical modes are temporal modes.

11. The apparatus according to claim 10, wherein the interferometer is a time bin interferometer.

12. The apparatus according to claim 11, wherein the time bin interferometer comprises at least one temporal mode coupling device, and wherein a temporal mode coupling device comprises a reconfigurable beamsplitter and a delay line, the delay line configured to connect one input port of the reconfigurable beamsplitter with one output port of the reconfigurable beamsplitter.

13. The apparatus according to claim 12, further comprising control circuitry for controlling an effective reflection coefficient of the reconfigurable beamsplitter.

14. The apparatus according to claim 13, wherein the time bin interferometer comprises at least one quantum memory device comprising an atomic system.

15. A method for entangling a plurality of N photonic multiqubit states, wherein N is an integer greater than two, the method comprising performing a N-qubit state measurement on a set of photonic qubits, the set comprising one photonic qubit from each of the N photonic multiqubit states, wherein performing the N-qubit state measurement comprises:
dual-rail encoding each photonic qubit of the set as probability amplitudes corresponding to the photon occupation of two orthogonal optical modes;
providing the dual-rail encoded photonic qubits to an interferometer, the interferometer configured to:
perform a beamsplitter interaction on the first mode of the first qubit and the second mode of the N^{th} qubit; and
perform a beamsplitter interaction on the second mode of the j^{th} qubit and the first mode of the (j+1)^{th} qubit for all j between 1 and N−1, wherein j is an integer; and
measuring a photon occupation of optical modes output from the interferometer.

16. The method according to claim 15, further comprising, based on the measured photon occupation of the output modes, performing corrective operations on at least one unmeasured photonic qubit of the entangled state.

17. The method according to claim 15, wherein at least one photonic multiqubit state comprises a Bell state.

18. The method according to claim 15, wherein at least one photonic multiqubit state comprises a 3-qubit GHZ state.

19. The method according to claim 15, wherein the optical modes are spatial modes.
